(19) United States
(12) Patent Application Publication
(10) Pub. No.: US 2013/0196163 A1
(43) Pub. Date: Aug. 1, 2013

(54) COMPOSITE GLASS LAMINATE AND WEB PROCESSING APPARATUS

(71) Applicant: 3M INNOVATIVE PROPERTIES COMPANY, St. Pual, MN (US)

(72) Inventor: Ronald P. Swanson, Woodbury, MN (US)

(73) Assignee: 3M INNOVATIVE PROPERTIES COMPANY, ST. PAUL, MN (US)

(21) Appl. No.: 13/738,382

(22) Filed: Jan. 10, 2013

Related U.S. Application Data
(60) Provisional application No. 61/593,076, filed on Jan. 31, 2012.

(51) Int. Cl. B32B 17/06

(52) U.S. Cl. CPC B32B 17/061
USPC 428/426; 156/199

(57) ABSTRACT

A glass composite laminate in the form of a web of indefinite length having a glass layer and a reinforcing layer, and with the thickness of the reinforcing layer chosen such that the neutral surface with respect to bending of the glass composite laminate web does not lie within the glass layer. A method of processing the glass composite laminate web so that it can be handled without being bent in such a way as to place the glass layer in tension due to bending stresses is also disclosed. The glass composite laminate web is conveniently provided as a wound roll where the reinforcing layer forms the outer surface of the roll and the glass layer forms the inner surface of the roll.

### BACKGROUND

Composite glass laminates having a thin glass layer (approximately 4 μm to 500 μm thick) and a thin plastic layer (approximately 1 μm to 200 μm thick) are described in patents such as GB 1 319 8456 and U.S. Pat. No. 6,815,070. Such glass composites are useful because the glass layer has high moisture and gas barrier properties, high dimensional stability, high scratch resistance, high modulus, high clarity, and low haze. However, the glass layer is brittle, therefore a reinforcing layer of plastic is utilized to impart improved toughness and to reduce glass splinters in the event of glass breakage.

### SUMMARY

To further improve web handling of the composite glass laminate it has now been found that the thickness of the glass layer and the thickness of the reinforcing layer should be controlled such that the neutral surface in bending for the composite falls outside of the glass layer. It is then possible when conveying a web of such a composite glass laminate along a web path in a web processing apparatus comprising a plurality of web handling elements, to ensure that the glass composite laminate is oriented with the glass layer on a concave side of any bend at each of the plurality of web handling elements. This allows the glass layer to be in compression from bending stresses and not subjected to tensile bending stresses, which could cause the glass layer to easily break.

Brittle materials, such glasses and ceramics, have very high ultimate compressive stress properties and are quite robust. However, when glass is subjected to tensile loads, small defects can cause stress concentrations and possible catastrophic failure at relatively low nominal tensile stress levels. If composite glass laminates are run through a conventional web processing apparatus, the small defects could easily create the stress concentrations that would cause the web to break at low levels of nominal tension since the composite glass laminate would be subjected to positive bending stresses on either side of the neutral surface. These tensile stresses would come from web tension and bending stresses as the glass composite laminate wraps rollers when the glass layer is facing away from the roller's surface and instead forms the outside radius as the glass composite laminate wraps the roller.

Hence, in one aspect the invention resides in a glass composite laminate in the form of a web of indefinite length comprising a glass layer and a reinforcing layer, wherein the neutral surface with respect to bending of the web does not lie within the glass layer.

In a second aspect the invention resides in an article of manufacture comprising a wound roll of a web of indefinite length material, the web comprising a glass layer and a reinforcing layer, wherein the neutral surface with regard to bending of the web does not lie within the glass layer, and wherein the reinforcing layer forms the outer surface of the roll and the glass layer forms the inner surface of the roll.

In a third aspect, the invention resides in a method for processing a glass composite laminate in the form of a web of indefinite length, comprising: providing a glass composite laminate comprising a glass layer and a reinforcing layer, wherein the neutral surface with respect to bending of the web does not lie within the glass layer; and conveying the web along a web path in a web processing apparatus comprising a plurality of web handling elements, such that when the glass composite laminate is redirected by the plurality of web handling elements, the glass composite laminate is oriented with the glass layer on a concave side of a bend at each of the plurality of web handling elements.

### BRIEF DESCRIPTION OF THE DRAWINGS

Repeated use of reference characters in the specification and drawings is intended to represent the same or analogous features or elements of the disclosure.

FIG. 1 shows a glass composite laminate from the side view having a thin glass layer, a reinforcing layer, and an optional adhesive layer.

FIG. 2 shows a glass composite laminate from a side view wound into a roll in a specific manner.

FIG. 3 shows a web processing apparatus designed such that the glass layer of the glass composite laminate is subjected to compression when the composite's direction is changed by web handling elements in the apparatus.

### DEFINITIONS

As used herein, variations of the words “comprise”, “have”, and “include” are legally equivalent and open-ended. Therefore, additional non-recited elements, functions, steps or limitations may be present in addition to the recited elements, functions, steps, or limitations.

As used herein, a “web handling element” is a device used to change or control the direction of the web through a web processing apparatus. Suitable web handling elements include idler rolls, dancer rolls, air turn guides, floatation dryers, coaters, spreaders, web guides, unwinds, and winders.

### DETAILED DESCRIPTION

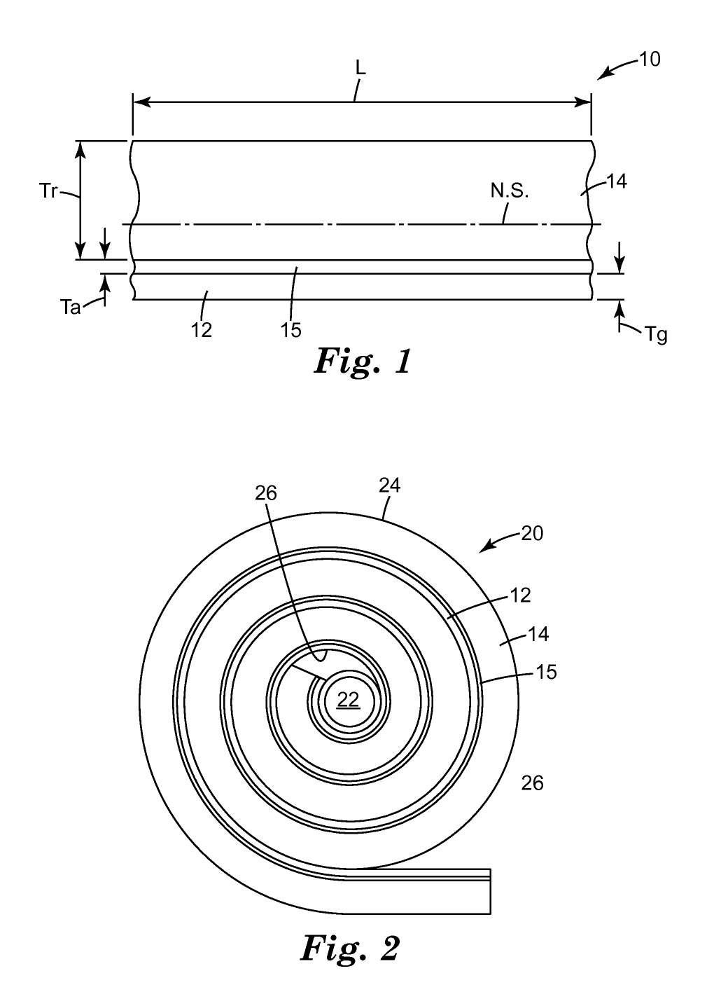

Referring to FIG. 1, a glass composite laminate 10 is shown comprising a glass layer 12 (glass film), a reinforcing layer 14, and an optional adhesive layer 15. The glass layer 12 has a thickness designated as: Tg, the reinforcing layer has a thickness designated as: Tr, and the optional adhesive layer has a thickness designated as: Ta. To ensure optimum web handling of the glass composite layer, the thickness of each layer is chosen such that the neutral surface, N.S., in bending for the composite laminate is contained within the reinforcing layer or within the optional adhesive layer and not contained within the glass layer.

The glass composite laminate has a length, L, in the machine direction significantly longer than the width of the laminate in the cross-machine direction as it is conveyed through the web processing apparatus such that the laminate can be characterized as a web. Often the length, L, is indeterminate in the sense that the glass composite laminate is wound into a roll of a specific diameter regardless of the length of the laminate needed to accomplish that desired size while recognizing that suitable sensors can accurately measure the specific length of the laminate, L, which was wound into the roll.

The following equation calculates the minimum reinforcing layer's thickness given the desired thickness of the glass layer, Tg, and optional adhesive layer, Ta, to ensure that the neutral surface for bending of the glass composite laminate is not within the glass layer. If no adhesive layer is used or a very thin/negligible adhesive layer or pattern is used the following equation should be employed:

$$Tr \geq \sqrt{( \frac{Eg}{Er} )} \times Tg$$

Where: Tr is the thickness of the reinforcing layer
Eg is the modulus of elasticity of the glass layer
Er is the modulus of elasticity of the reinforcing layer, and
Tg is the thickness of the glass layer.

Consistent metric or English units should be used such as gigapascals for modulus of elasticity and micrometers for thickness.

When an optional adhesive layer is used the following equation should be employed to calculate the minimum reinforcing layer's thickness:

$$Tr \geq \sqrt{( \frac{Ea}{Er} ) {Tg}^{2} + ( 1 - \frac{Ea}{Er} ) {Ta}^{2}} - Ta$$

Where: Tr is the thickness of the reinforcing layer
Eg is the modulus of elasticity of the glass layer
Er is the modulus of elasticity of the reinforcing layer
Ea is the modulus of elasticity of the adhesive layer
Ta is the thickness of the adhesive layer, and
Tg is the thickness of the glass layer.

Consistent metric or English units should be used such as gigapascals for modulus of elasticity and micrometers for thickness. As stated, both equations calculate the minimum thickness for the reinforcing layer and a thicker layer can be used if desired.

Suitable glass films can be obtained from manufacturers such as Nippon Electric Glass Co., LTD, Tokyo, Japan and Asahi Glass Company, Tokyo, Japan. Often the glass will be borosilicate glass, aluminosilicate glass, aluminoborosilicate glass or alkali-free borosilicate glass.

Suitable reinforcing layers can include any ductile material that reinforces and strengthens the brittle glass layer during web handling operations. Various reinforcing layers can be used such as films of PET (polyethylene terephthalates), polyolefins, polyvinyl chloride, polyamides, polyvinylidene chloride, regenerated cellulose, cellulose acetates, polystyrene, silicone polymer, sol-gel polymer such as Ormocere®, polycarbonate, polyether sulphone, polyacrylate, polyimide, cycloolefin copolymer or mixed polymers, copolymers of the foregoing, or layers of the foregoing. Metals can also be used of the reinforcing layer such as copper, silver, nickel, zinc, aluminum, and alloys of the foregoing. Aluminum is considered particularly suitable as a reinforcing layer for bonding to the glass layer since its thermal expansion coefficient and modulus of elasticity are similar to glass. The coefficient of thermal expansion for aluminum is 22 μm/m-° C. and for glass is 3 to 13 μm/m-° C. The modulus of elasticity for aluminum is 69 GPa and for glass is 73 GPa. These properties make aluminum an excellent choice for constructing a composite glass laminate intended to be converted with a web processing apparatus. Another particularly suitable reinforcing layer is 3M Safety and Security Window film Ultra S600 which is a 6 mil (152 μm) thick film of multiple layers of polyethylene terephthalate material.

The following two examples illustrate glass composite laminates having their neutral surface of bending located in the reinforcing layer instead of the glass layer. Example 1: A 50 μm (2 mil) glass layer having a 203 μm (8 mil) PET polymer reinforcing layer. In this example, the neutral surface is located approximately 2 μm into the PET layer from the glass/PET interface. Example 2: A 50 μm (2 mil) glass layer having a 50 μm (2 mil) aluminum foil reinforcing layer and a 12 μm (0.5 mil) adhesive layer attaching the aluminum foil to the glass layer. In this example, the neutral surface is located approximately 5 μm into the adhesive layer from the glass/adhesive interface.

Suitable adhesives can be used to bond the reinforcing layer to the glass layer. Alternatively, suitable reinforcing layers may be directly applied to the glass layer without an adhesive layer. In some embodiments, the adhesive layer may be optically clear when the reinforcing layer is not removed and the final product is used as a touch screen display. In other embodiments, the adhesive layer is a temporary bond used for the purpose of attaching the reinforcing layer during converting operations or shipping with the reinforcing layer removed at some point thereafter. For example, oftentimes use of an aluminum reinforcing layer will require removal of the aluminum layer at some point such that the transparent properties of the glass layer are usable in the final product. Therefore the method according to the present invention may optionally include stripping the reinforcing layer from the glass layer.

Therefore, when an adhesive layer is used between the glass layer and the reinforcing layer, the choice of adhesive is often guided first by whether the reinforcing layer is transparent (e.g. polymer), and intended to remain with the glass layer in the final product, or whether the reinforcing layer is non-transparent, (e.g. aluminum), and intended to be removed from the glass layer before the glass layer is incorporated in the final product.

If the former, one suitable adhesive is discussed in co-pending and co-assigned U.S. patent application Ser. No. 61/540/176, “A METHOD FOR MAKING AN OPTICAL ASSEMBLY,” which is hereby incorporated by reference. More particularly, this application discusses optically clear compositions that comprise the reaction product of a multifunctional (meth)acrylate oligomer; a reactive diluent comprising a monofunctional (meth)acrylate monomer having a viscosity of from about 4 to about 20 cps at 25° C.; and a plasticizer. The multifunctional (meth)acrylate oligomer comprises any one or more of: a multifunctional urethane (meth)acrylate oligomer; a multifunctional polyester (meth)acrylate oligomer; and a multifunctional polyether (meth)acrylate oligomer. Such a material can be cured against the glass layer by, e.g. UV radiation. Additional discussion of optically clear adhesives can be found in co-pending and co-assigned PCT Application 2010/111316A2, “OPTICAL ASSEMBLY HAVING A DISPLAY PANEL AND METHODS OF MAKING AND DISASSEMBLING SAME,” which is also hereby incorporated by reference.

When the reinforcing layer is non-transparent, (e.g. aluminum), and intended to be removed from the glass layer before the glass layer is incorporated in the final product, pressure-sensitive adhesives are generally considered suitable, and a specific choice of adhesive tends to turn on having the adhesive peel cleanly from the glass layer, remaining with the reinforcing layer. Acrylic adhesives, silicone adhesives, and styrenic block copolymer (Kraton™) adhesives, among others, are considered suitable.

The thickness of the glue layer is dependent upon the product application, the relative thicknesses of the glass layer and the reinforcing layer, whether a temporary or permanent bond is desired, and the desired strength of the lamination. In general, the thickness of the glue layer can be from 1 μm to about 10 μm or from 2 μm to 5 μm. Additionally, the glue layer can be substantially continuous or applied in a discontinuous pattern of lines or dots. For example, machine direction or cross-machine direction lines or cross-hatched lines of adhesive can be used. Known adhesion promoters can be applied to either the glass layer or the reinforcing layer to improve bonding within the glass composite laminate.

Referring now to FIG. 2, an article of manufacture comprising a wound roll 20 of a web of indefinite length material of the glass composite laminate 10 is shown. The wound roll 20 is spiral wound such that the glass layer 12 assumes a smaller radius of curvature for each wound layer than the reinforcing layer 14. This keeps the glass layer 12 in compression from bending stresses as it is wound because the neutral surface of the glass composite laminate 10 resides in the reinforcing layer 14 or optional adhesive layer 15, and does not lie within the glass layer 12. The glass composite laminate 10 may be wound around a core 22 or it may be a core-less wound roll. When the roll is properly wound, the outer surface 24 is the reinforcing layer 14 and the inner surface 26 is the glass layer 12, touching the core 22 if a core is provided. Winding the glass composite laminate 10 into a roll in the opposite direction would place the glass layer 12 in tension possibly leading to breakage of the glass layer as the roll is wound.

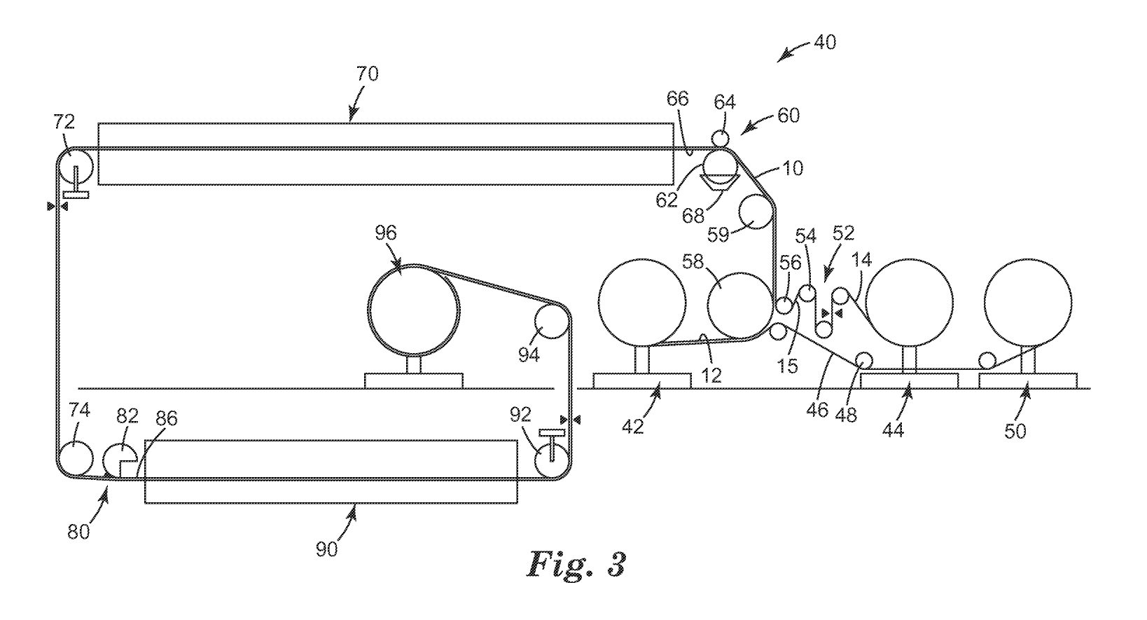

By extension, the glass composite laminate 10 is conveniently processed on a web processing apparatus that reduces the tendency for glass layer 12 to be in tension; especially, while being redirected by web handling elements. In such a web processing apparatus, one or more converting operations such as unwinding, coating, printing, slitting, drying, laminating, treating, and winding may occur. Referring now to FIG. 3, a web processing apparatus 40 of such a type is shown. In the illustrated embodiment, the glass composite laminate 10 is formed from the unwinding glass layer 12 and laminated by the adhesive layer 15 to the reinforcing layer 14 within the web processing apparatus 40, but an alternate web processing apparatus according to the present invention could be created wherein a wound roll 20 of the glass composite laminate created in an earlier process is the input material.

The web processing apparatus 40 includes an unwind stand 42 for the glass layer 12, and an unwind stand 44 for the reinforcing layer 14. In the illustrated embodiment, the reinforcing layer 14 conveniently has an adhesive layer 15 already pre-applied to one surface. In other embodiments, a pressure-sensitive or a hot-melt adhesive can be applied at a separate coating station located after the unwind stand 44 and prior to the nip between rolls 56 and 58. Further, in the illustrated embodiment, the glass layer 12 on the unwind stand 42 is shown interleaved with a protective sheet 46, which is conveyed via rollers 48 to a winding stand 50 as the glass layer 12 is unwound.

The reinforcing layer 14 is conveyed through a dancer roller assembly 52 for tension control, and then around roller 54 towards a nip between nip roller 56 (conveniently with a soft rubber surface) and backup roller 58 where the glass composite laminate 10 is formed. Conveniently, the backup roller 58 has a large radius so that the curvature of the glass layer 12 is minimized before the formation of the glass composite laminate 10.

The glass composite laminate 10 is then conveyed around idler roll 59 to a first coating station 60, which in this embodiment is a roll coater, where the glass composite laminate 10 passes between a coating roll 62 and a nip roll 64. The coating roll places a first coating material 66 (e.g. a primer) from the supply pan 68 onto the free surface of the glass layer 12. The coated glass composite laminate 10 then enters a first drying station 70 to dry the first coating material 66.

After passing around roller 72 and roller 74, the glass composite laminate 10 is then conveyed to a second coating station 80, which in this embodiment is a notched bar coater, where the glass composite laminate 10 contacts a notched bar 82 on the free span. The notched bar 82 spreads a second coating material 86, (e.g. a hard coat or an anti-reflective layer), onto the glass composite laminate 10. The twice coated glass composite laminate 10 then enters a second drying station 90 to dry the second coating material 86.

After passing around roller 92 and roller 94, the glass composite laminate 10 is then conveyed to a windup stand 96. It is to be observed that at all times in this embodiment of a web path once the glass composite laminate 10 has been formed, when the glass composite laminate 10 is bent and redirected by a web handling element, the glass layer is on the concave side of the bend, and the glass layer 12 is only placed into compression by the bending stresses about the neutral surface.

Although the illustrated embodiment includes only web handling elements that place the glass layer in compression when the web is redirected, modern flexible glasses can endure some degree of tension due to bending as seen in glass film roll on unwind stand 42. The method of the present invention presumes that web handling elements that place the web in a modest amount of tension due to bending stresses, and/or mildly bend the web so that the glass layer is on the convex side, might additionally be present and still describe a method within the scope of the claims.

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A glass composite laminate in the form of a web of indefinite length comprising a glass layer and a reinforcing layer, wherein the neutral surface with respect to bending of the web does not lie within the glass layer.

2. The glass composite laminate according to claim 1 wherein an adhesive layer is not present between the glass layer and the reinforcing layer, and wherein a thickness, Tr, of the reinforcing layer is satisfied by the following equation:
$$Tr \geq \sqrt{( \frac{Eg}{Er} )} \times Tg$$

3. The glass composite laminate according to claim 1 further comprising an adhesive layer disposed between the glass layer and the reinforcing layer.

4. The glass composite laminate according to claim 1 wherein the adhesive layer is an optically clear adhesive.

5. The glass composite laminate according to claim 3 wherein the reinforcing layer is a metal.

6. The glass composite laminate according to claim 5 wherein the metal is aluminum.

7. The glass composite laminate according to claim 3 wherein a thickness, Tr, of the reinforcing layer is satisfied by the following equation:
$$Tr \geq \sqrt{( \frac{Ea}{Er} ) {Tg}^{2} + ( 1 - \frac{Ea}{Er} ) {Ta}^{2}} - Ta$$

8. An article of manufacture comprising a wound roll of a web of indefinite length material, the web comprising a glass layer and a reinforcing layer, wherein the neutral surface with regard to bending of the web does not lie within the glass layer, and wherein the reinforcing layer forms the outer surface of the roll and the glass layer forms the inner surface of the roll.

9. The article of manufacture according to claim 8 wherein an adhesive layer is not present between the glass layer and the reinforcing layer, and wherein a thickness, Tr, of the reinforcing layer is satisfied by the following equation:
$$Tr \geq \sqrt{( \frac{Eg}{Er} )} \times Tg$$

10. The article of manufacture according to claim 8 further comprising an adhesive layer disposed between the glass layer and the reinforcing layer.

11. The article of manufacture according to claim 10 wherein the adhesive layer is an optically clear adhesive.

12. The article of manufacture according to claim 10 wherein the reinforcing layer is a metal.

13. The article of manufacture according to claim 12 wherein the metal is aluminum.

14. The article of manufacture according to claim 10 wherein a thickness, Tr, of the reinforcing layer is satisfied by the following equation:
$$Tr \geq \sqrt{( \frac{Ea}{Er} ) {Tg}^{2} + ( 1 - \frac{Ea}{Er} ) {Ta}^{2}} - Ta$$

15. A method for processing a glass composite laminate in the form of a web of indefinite length, comprising:
providing a glass composite laminate comprising a glass layer and a reinforcing layer, wherein the neutral surface with respect to bending of the web does not lie within the glass layer; and
conveying the web along a web path in a web processing apparatus comprising a plurality of web handling elements, such that when the glass composite laminate is redirected by the plurality of web handling elements, the glass composite laminate is oriented with the glass layer on a concave side of a bend at each of the plurality of web handling elements.

16. The method according to claim 15 wherein the providing a glass composite laminate comprises laminating the reinforcing layer to the glass layer using an adhesive layer in the web processing apparatus.

17. The glass composite laminate according to claim 15 wherein an adhesive layer is not present between the glass layer and the reinforcing layer, and wherein a thickness, Tr, of the reinforcing layer is satisfied by the following equation:
$$Tr \geq \sqrt{( \frac{Eg}{Er} )} \times Tg$$

18. The method according to claim 15 wherein the glass composite laminate comprises the glass layer and an adhesive layer joining the reinforcing layer to the glass layer and wherein a thickness, Tr, of the reinforcing layer is satisfied by the following equation:
$$Tr \geq \sqrt{( \frac{Ea}{Er} ) {Tg}^{2} + ( 1 - \frac{Ea}{Er} ) {Ta}^{2}} - Ta$$

19. The method according to claim 18 wherein the adhesive layer is an optically clear adhesive.

20. The method according to claim 15 further comprising stripping the reinforcing layer from the glass layer.
